(19) United States
(12) Patent Application Publication
(10) Pub. No.: US 2005/0223914 A1
(43) Pub. Date: Oct. 13, 2005

(54) Device for compacting waste in containers

(76) Inventor: Roger Soler, Hericourt (FR)

Correspondence Address: EGBERT LAW OFFICES, 412 MAIN STREET, 7TH FLOOR, HOUSTON, TX, 77002, US

(21) Appl. No.: 10/516,127

(22) PCT Filed: May 30, 2003
(86) PCT No.: PCT/FR03/01636

§ 371 Date: Nov. 24, 2004

(30) Foreign Application Priority Data
May 30, 2002 (FR) 02/06622

(51) Int. Cl. B30B 3/02

(52) U.S. Cl. 100/210; 100/68

(57) ABSTRACT

The invention relates to a device for compacting waste which is disposed in containers that are open at the top thereof. The inventive includes a compactor roller which is pivot-mounted to one end of a handling arm, the other end of the arm being mounted to a support frame in a collapsible manner. The device is characterized in that at least one of the transverse ends of the support frame has an anchoring device which can co-operate with a lift and load hook of a of a container transport vehicle.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention relates to a device for compacting waste which is disposed in containers that are open at the top thereof, which device comprises a compactor roller which is rotationally mounted to one end of a handling arm, the other end of which is mounted to a support frame, namely in a collapsible way.

The present invention will find its application in the field of the waste-compacting devices.

### BACKGROUND OF THE INVENTION

In this respect, there is already known, in particular from EP-0,042,580, such a device comprising a compactor roller mounted to the end of a hinged arm so as to be capable of plunging into a container through its opening in the upper portion.

More exactly, this hinged arm is inserted in a directional way against a bracket topping a base plate capable of being slit under a container, so as to maintain its stability during compaction.

Also, from FR-A-2,630,718 is known a compacting device comprising a frame above which is capable of moving a press likely to plunge into the container that will have been previously placed in the cage defined by said frame. After use, the latter can be moved by means of the same kind of vehicle as used for transporting the containers. In particular, at one of its transverse ends, this frame is provided with coupling means through which it can be seized by the hook for lifting and loading onto such a container transport vehicle.

It should be noted that the compactor devices described in each of these previous documents are functional when they rest on the ground and the container the contents of which has to be compacted defines the counterweight necessary to compensate for the compacting force imparted by a compactor roller or a press. In addition, since it is not mobile, after compaction of the contents of a container, the latter should be removed, in order to leave room for another container for carrying out a new compaction operation.

It is obvious that these successive handling operations of the containers represent a considerable waste of time and require the use of adequate transport vehicles. In particular, such containers usually rest on two longitudinal beams and include, in the rear portion, rolling means in the form of rollers, while in the front portion are provided coupling means which a handling hook provided on an automotive transport vehicle is capable of co-operating with. More exactly, through this hook and said coupling means the transport vehicle is capable of lifting said container at its front portion, in order to gradually draw it onto its loading platform.

Furthermore, from EP-1,046,190 is known a similar device for compacting waste, taking into consideration that the bracket receiving the hinged arm provided with the compactor roller is, here, mounted on a platform from where extend, in the front portion, two longitudinal beams maintaining between them a significant distance and provided, at their free end, with a metal roller with a reduced cross-section. In its rear portion, this platform includes directional wheels of larger dimensions and maintaining between them a smaller distance.

In this same rear portion, the platform also includes retractable struts, with a view to improving its stability during the compacting phase.

This device as described in this previous document is self-propelled. More exactly, the rear wheels are mounted on both sides of a central hub pivoting about a vertical axis and on which act said driving means, in particular of a hydraulic type.

Though, contrarily to the compacting device described in EP-0,042,580, the one corresponding to EP-1,046,490 is mobile and can therefore be brought close to a container to compact the waste contained in it, and not inversely, this mobility has a cost.

Thus, here the platform has to be provided with the device of rolling means, some of which are directional, and it has to be provided with autonomous driving means and a hydraulic aggregate.

In this respect, it should be noted that from GB-2,261,832 is also known a device for compacting waste the hinged arm of which, provided with its compactor roller, is finally provided on an automotive vehicle, of the type public works vehicle, including a control station. Though this vehicle has a very great mobility and can very quickly pass from one container to another, it proves to be of an even higher cost price than a self-propelled device as described above.

### BRIEF SUMMARY OF THE INVENTION

The present invention has been able to find a perfect compromise in this field of the compaction of waste in containers that are open in the upper portion, in particular through an extremely simple device. In particular, the latter allows to make use, as means for displacement, but also as a bearing structure, of the transport vehicles which are usually present on the industrial site where such containers of waste are stored. In this context, it has also been devised that such a transport vehicle can, eventually, supply the compacting device with the power which is necessary for its operation.

In brief, the compactor device according to the invention is of a structure astutely adapted to be easily positioned on the loading platform of a transport vehicle for containers which allows to bring it very quickly in front of such a container stored on any industrial site, with a view to compacting its contents.

Thus, the invention relates to a device for compacting waste which is disposed in containers that are open at the top thereof, which device comprises a compactor roller which is rotationally mounted to one end of a handling arm, the other end of which is mounted to a support frame, namely in a collapsible way, characterized in that said bearing frame is essentially comprised of two longitudinal beams defining slides for loading said device onto the loading platform of a container transport vehicle and is provided, at one of its transverse ends, with coupling means designed capable of cooperating with a lifting and loading hook said container transport vehicle includes.

Though, in a first embodiment, this device can be provided with autonomous driving means, it can, in a simplified embodiment, include means, in the form of a hydraulic and/or pneumatic and/or electric power take-off, for connection to independent driving means, in particular defined by said transport vehicle.

Since container transport vehicles are present either permanently or periodically on the sites where containers with waste are stored, it has been devised that such a vehicle can ensure, in particular during the periods in which it is not used for other purposes, the picking up of the compactor device. This picking up consists in conferring to the latter the necessary mobility and stability to allow it to be individually brought in front of each container in which waste has to be compacted.

This vehicle can eventually also provide it with the necessary power, either for driving the compactor roller or for controlling and moving the hinged arm it is provided with.

In brief, in this case, the compactor device is without rolling means, in particular of a directional type. Furthermore, since its stability no longer needs to be ensured by the container in which the compacting operation is carried out, its structure does no longer directly depend on that of such a container. Accordingly, it proves to be of a very simple design, without this having any influence on its performances or the easiness of its use.

Deprived of autonomous driving means, this device proves to be, in addition, extremely economical.

Further aims and advantages of this invention will become clear when reading the following description, which refers to an embodiment given by way of an indicative and non-restrictive example.

### BRIEF DESCRIPTION OF THE SEVERAL VIEWS OF THE DRAWINGS

This description will be better understood when referring to the attached drawing, in which:

FIG. 1 is a schematic and perspective view of the compactor device according to the invention;

FIG. 2 is a schematic and elevational view of this compactor device during its picking up by a containers transport vehicle;

FIG. 3 is a schematic and elevational view of this device, mounted on a transport vehicle and during the compaction of waste contained in a container.

### DETAILED DESCRIPTION OF THE INVENTION

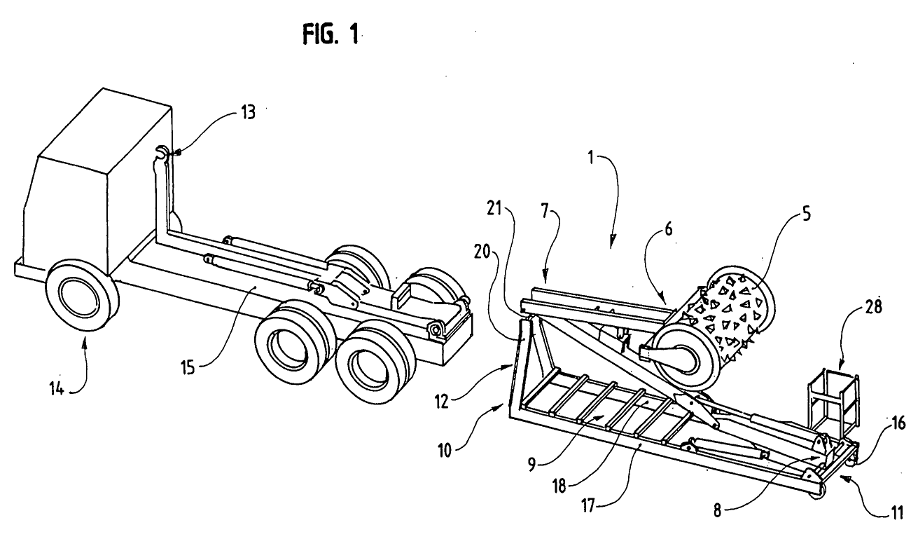

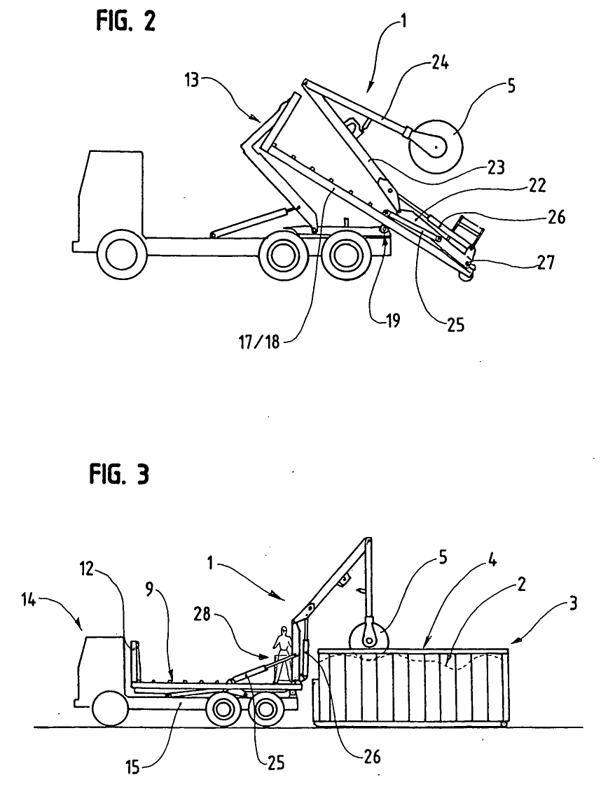

As shown in FIG. 1, the present invention relates to a driving device 1 integrating at least two synchronous brushless electric motors 2, 3 one embodiment of which is shown in FIG. 2, FIGS. 3 and 4 contributing to understanding its operation.

In particular, such a synchronous brushless electric motor is of the multiphase type and comprises a stator portion 4 excited by electric coils 5 corresponding to the various phases 6, taking into consideration that this motor 2, 3 also includes a rotor 8 with N pairs of rotor poles 9 radially magnetized in an alternate direction.

Within the framework of the embodiment corresponding to the figures of the attached drawing, N is equal to 5.

The stator portion 4 includes P poles 10. They are grouped consecutively three by three, so as to define a phase formed of a W-shaped circuit grouping three consecutive stator poles, the central stator pole 11 bearing the coil 3 of the corresponding phase 6.

Such a motor 2, 3 includes means 12 for detecting the position of the rotor 8, these means being shown in the drawings in the form of magnetic sensors, more exactly of Hall effect sensors 13. Advantageously, these detecting means 12 being positioned, between each of the phases 6, in a recess 14 equidistant between two consecutive stator poles 10 not belonging to the same phase 6.

FIG. 4 shows the electric wiring diagram of the three phases 6 of a motor 2, designated 6a, 6b, 6c, respectively, as well as the three Hall sensors 13, designated 13a, 13b, 13c, respectively. The star-shaped mounting of the windings 5 requires three output wires for the current supply for the phases 6. There are always two windings 5 supplied with current at the same time and a winding 5 in which no current flows.

In this embodiment using, as detecting means 12, Hall effect sensors 13, these have a common current supply and a common ground, hence a classical mounting with five dedicated wires.

FIG. 5 is a vectorial representation of the three phases 6a, 6b, 6c of the motor 2, 3 and the representation of the six angular sectors 15 determined by the three position-detecting elements 13 and designated 15a, 15b, 15c, 15d, 15e, 15f, respectively, in anti-trigonometric direction.

The three phases 6a, 6b, 6c are electrically offset by 120°. By using a bipolar current-supply mode, six stable positions are achieved in a pair of poles, here shown by means of the vectors 16a, 16b, 16c, 16d, 16e, 16f. For example, the vector 16a shows the stable position achieved by feeding the motor between the output wires 17a and 17b, the current flowing from 17a to 17b.

The switching points of the position detectors 13 are graphically located on the same vectors. Accordingly and through this type of mounting, the rotation of the motor is achieved by applying two by two to the coils of the phases successive current-supply sequences, well-known to the specialist in the art.

Finally, according to the invention the driving device 1, including at least two motors of this type 2, 3, is provided with at least one electronic power unit 18 for the current supply to their coils 5 of the phases 6, taking into consideration that it includes, furthermore, one single electronic synchronization logical unit 19 for their operation.

In particular, this electronic synchronization logical unit 19 is designed capable of controlling, depending on the position determined by the detection means 12 for the rotors 8 of each motor 2, 3, according to an identical current-supply sequence, the phases 6 of each of these motors 2, 3.

Thus, through the driving device 1 according to the invention, the motors 2, 3 do not include an own electronic logical unit controlled by an independent synchronization circuit to control the sequences of current supply for their phases. Indeed, in this case, there is only one electronic synchronization logical unit which is capable of applying to the motors only sequences of current supply for their phases which are necessarily identical.

Finally, one understands very well that none the motors 2, 3 intended at operating synchronously of the driving device 1 can be offset by more than one electric rotation with respect to the other motors.

In the case of the above-described three-phase motors 2, 3, this maximum electrical offset corresponds to a 180° rotation of the rotor 8.

Based on this observation and on the very principle of the operation of this type of synchronous brushless motor, the electronic synchronization logical unit 19 is designed capable of determining, depending on the detected position of their rotor 8, the sequence of current supply to be applied in an identical way to the phases 6 of these motors 2, 3.

More particularly, in this way the coils 5 of these motors 2, 3 are supplied with current in an identical, in order to achieve, as the case may be, a maximum torque at the level of the rotor of the delayed motor and, on the contrary, a reduced, even zero couple, at the rotor corresponding to the fast motor.

Finally, as is noted from the preceding description, the driving device according to the invention is not only of a very simple design, compared to the known devices, since it now includes only one electronic logical unit 19, but, in addition, it allows to guarantee a perfect synchronization of operation of the motors 2, 3, since no offset by more than one electric rotation can occur in this case.

It should be noted that, if the motors 2, 3 are in addition identical and designed capable of operating under the same voltage, the driving device can be limited to one single electronic power unit 18 for controlling all the motors, as appears in FIG. 2.

Furthermore, since, for a current supply in an identical way for the phases of the motors 2, 3, the position of each of their rotors is taken into consideration, the blocking of any of them for any reason whatsoever necessarily results into a current supply to these motors according to identical sequences, so that all the rotors are then maintained in a fixed position until the restoring of the failing motor.

The driving device according to the invention can find its application, typically, in the field of the control of the windscreen wipers of motor vehicles.

In this case, it very often occurs that there are several windscreen wiper brushes synchronously actuated by their own motors.

There are also known systems for adjusting pedal blocks of such a vehicle, which adjustment must be identical for each pedal. Therefore, to each of the latter is associated a motor. The various motors are designed capable of operating synchronously through the driving device according to the invention.

1. Device for compacting waste disposed in containers open at a top thereof, said device comprising:
a compactor roller rotationally mounted to one end of a handling arm another end of the arm being mounted to a support frame, namely in a collapsible way; and
a bearing frame comprised of two longitudinal beams defining slides for loading onto a loading platform of a container transport vehicle said bearing frame, at a transverse end thereof, being comprised of a coupling means co-operating with a lifting and loading hook of said container transport vehicle.

2. Device for compacting waste according to claim 1, wherein said bearing frame further comprises, at a transverse end thereof opposite the coupling means, a rolling means comprised of metal rollers pivotally mounted about a horizontal-transverse axis of rotation.

3. Device for compacting waste according to claim 1, wherein said coupling means are defined, at the transverse end of the bearing frame, by a reversed V-shaped structure carrying, at an upper end thereof, a coupling bar cooperative with said lifting and loading hook.

4. Device for compacting waste according to claim 1, wherein said handling arm is mounted on said bearing frame in a vicinity of the transverse end of the bearing frame, opposite said coupling means.

5. Device for compacting waste according to claim 1, wherein said handling arm is comprised of two or more lengths hinged with respect to each other and actuated through driving organs comprised of hydraulics jacks or pneumatic jacks or both.

6. Device for compacting waste according to claim 1, further comprising: a control station for controlling operation.

7. Device for compacting waste according to claim 1, further comprising: an autonomous driving means.

8. Device for compacting waste according to claim 1, further comprising: means for connecting, being comprised of a hydraulic and/or pneumatic and/or electric power take-off, to an independent driving means defined by said transport vehicle.
